(19) United States
(12) Patent Application Publication
(10) Pub. No.: US 2016/0189142 A1
(43) Pub. Date: Jun. 30, 2016

(54) METHODS AND SYSTEMS OF SECURE CREDIT-CARD COMMERCE TRANSACTIONS

(71) Applicants: VARDARAJAN CHANDRU, San Jose, CA (US); ASHOK SUBRAMANIAM, MORGAN HILL, CA (US)

(72) Inventors: VARDARAJAN CHANDRU, San Jose, CA (US); ASHOK SUBRAMANIAM, MORGAN HILL, CA (US)

(21) Appl. No.: 14/847,001

(22) Filed: Sep. 7, 2015

Related U.S. Application Data
(60) Provisional application No. 62/047,636, filed on Sep. 8, 2014.

(51) Int. Cl. G06Q 20/34; G06Q 20/26; G06Q 20/12; G06Q 20/24

(52) U.S. Cl. CPC G06Q 20/354; G06Q 20/24; G06Q 20/26; G06Q 20/12

(57) ABSTRACT

In one aspect, a computerized method for secure credit card commerce transactions can include the step of receiving in a computer with a memory, from a user-side computing device, an electronic message that a user intends to use a credit card, wherein the electronic message comprises a request to activate the credit card, and wherein the credit card is initially in an inactive state. With at least one processor of the computer implementing the following steps can be implemented: placing the credit card in an active state; detecting that the credit card has been used for a commercial transaction; and placing the credit card in an inactive state after it has been detected that the credit card has been used for a commercial transaction.

### CROSS-REFERENCE TO RELATED APPLICATIONS

This application is a claims priority from U.S. Provisional Application No. 62/047,636, titled METHODS AND SYSTEMS OF SECURE CREDIT-CARD COMMERCE TRANSACTIONS and filed 8 Sep. 2014. This application is hereby incorporated by reference in its entirety.

### FIELD OF THE INVENTION

The invention is in the field of credit-card security systems and more specifically to a method, system and apparatus of secure credit card commerce transactions.

### DESCRIPTION OF THE RELATED ART

Fraudulent use of credit cards can cause a significant waste of resources for credit card companies. Additionally, credit card users can have their credit card information stolen. Stolen credit card information can be used to make fraudulent purchases. Users can be held liable for these fraudulent purchases. For example, a user can use her credit card to purchase a good from a merchant. This information can be stolen by an entity that hacks the merchant. The hacking entity can frequently use the credit card before the user is aware of the hack. Accordingly, methods and systems that increase credit card security can improve the user's credit card experience.

### SUMMARY OF INVENTION

In one aspect, a computerized method for secure credit card commerce transactions can include the step of receiving in a computer with a memory, from a user-side computing device, an electronic message that a user intends to use a credit card, wherein the electronic message comprises a request to activate the credit card, and wherein the credit card is initially in an inactive state. With at least one processor of the computer implementing the following steps can be implemented: placing the credit card in an active state; detecting that the credit card has been used for a commercial transaction; and placing the credit card in an inactive state after it has been detected that the credit card has been used for a commercial transaction.

### BRIEF DESCRIPTION OF THE DRAWINGS

FIG. 1 illustrates an example process for workload mobility across divergent platforms, according to some embodiments.

FIG. 2 illustrates an example system of a credit-card processing model, according to some embodiments.

FIG. 3 illustrates an example model of a process chain to enable/suspend/resume the active use a credit card, according to some embodiments.

FIG. 4 illustrates a process flow that can capture the resume/suspend operation with a card-scheme entity, according to some embodiments.

FIG. 5 illustrates an example system of randomizing user communication to a computerized system that implements process 100-400, according to some examples.

FIG. 6 depicts, in block diagram format, a credit/debit card mode management system, according to some embodiments.

FIG. 7 is a block diagram of a sample computing environment that can be utilized to implement various embodiments.

FIG. 8 illustrates another block diagram of a sample computing environment 800 with which embodiments may interact.

The Figures described above are a representative set, and are not an exhaustive set with respect to embodying the invention.

### DESCRIPTION

Disclosed are a system, method, and article of manufacture of secure credit card commerce transactions. The following description is presented to enable a person of ordinary skill in the art to make and use the various embodiments. Descriptions of specific devices, techniques, and applications are provided only as examples. Various modifications to the examples described herein can be readily apparent to those of ordinary skill in the art, and the general principles defined herein may be applied to other examples and applications without departing from the spirit and scope of the various embodiments.

Reference throughout this specification to “one embodiment,” “an embodiment,” ‘one example,’ or similar language means that a particular feature, structure, or characteristic described in connection with the embodiment is included in at least one embodiment of the present invention. Thus, appearances of the phrases “in one embodiment.” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art can recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, and they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

### DEFINITIONS

Application programming interface (API) can specify how software components of various systems interact with each other.

Acquiring bank (or acquirer) can be a bank or financial institution that processes credit or debit card payments on behalf of a merchant. The acquirer can accept and/or acquire credit card payments from the card-issuing banks within an association.

Card schemes can include the owners of a payment scheme, into which a bank or any other eligible financial institution can become a member. By becoming a member of the scheme, the member then gets the possibility to issue or acquire the transactions performed within the scheme. Exemplary card schemes include refers Visa®, MasterCard® and RuPay® card schemes.

Credit card can be a payment card issued to users as a system of payment. It allows the cardholder to pay for goods and services based on the holder's promise to pay for them.

Debit card can be payment card that provides the cardholder electronic access to bank account(s) at financial institutions. A debit card can bear a stored value with which a payment is made and/or relay a message to the cardholder's bank to withdraw funds from a payer's designated bank account. The debit card can be used instead of cash when making purchases. In some cases, the primary account number is assigned exclusively for use on the Internet and there is no physical debit card.

EMV stands for Europay, MasterCard and Visa, a global standard for inter-operation of integrated circuit cards (IC cards or “chip cards”) and IC card capable point of sale (POS) terminals and automated teller machines (ATMs), for authenticating credit and debit card transactions.

Fuel card or fleet card is used as a payment card most commonly for gasoline, diesel, and other fuels at gas stations.

JITAP server can be a Just-in-Time Activate-Process server.

QR code (abbreviated from Quick Response Code) can be a type of matrix barcode (e.g. a two-dimensional barcode, a machine-readable optical label that contains information about the item to which it is attached, etc.). In one example, a QR code can use four standardized encoding modes (e.g. numeric, alphanumeric, byte/binary, and kanji) to store data. Extensions may also be used.

### EXEMPLARY METHODS

In one embodiment, systems and methods provided herein provides control to consumers (e.g. credit/debit card users) to manage, their credit/debit cards, finances (as used here, a ‘credit card’ can also include other financial card methods such as debit cards and the like according to various embodiments). A scheme entity to store an extra piece of information about the consumer suspend/resume status along with their own active/inactive/deactivated status. It is noted that in some embodiments, credit/debit cards can include, inter alia: existing plastic cards embedded with bar codes, magnetic strips, and/or a smart chip (or any other store and retrieve mechanism); an EMV technology based smart cards, and their varied implementation used by any card-scheme companies that include gift cards, merchant cards, biometric and retina scan tied cards and QR code enabled variations of the above. In some embodiments, a scheme entity may be a brand name entity like Visa®, Master Card®, Discover®, American Express® or a co-branding financial Institution such as a Bank (e.g. Wells Fargo®, Barclay®), a fuel card, a store chain card, or any variations of similar businesses that do both debit and credit transactions.

In one example, consumers can have ultimate control to activate a credit card ‘just-in-time’ before the use of the card with a double-ended verification process as opposed to open-ended validity until explicit expiry date, liable for theft and hacking. Scheme companies can maintain the information about consumer's suspend/resume options. Consumers can be provided various statistics about what the limit of charge is and how much of that limit is available to charge (e.g. if the card is due for renewal, etc.). Consumers can be provided comprehensive information on their credit/debit card usage statistics for the duration of the credit/debit card validity, as well as late payments etc. and how to avoid credit score drops (e.g. via a web page and/or mobile device applications that obtains said information from a scheme entity server, etc.).

Some embodiments can include a ‘just-in-time activation of credit/debit/merchant cards' functionality. Consumers that have one or more credit/debit cards to activate, suspend, resume, reactivate, and deactivate can use one of their personal computing touch points like smart phones, PDAs, mobile devices (e.g. iPAD®, AndroidPAD®, etc.), wearable computers, smart watches, and/or other computing devices such personal computers. It is noted that the activate/suspend/resume/deactivate/reactivate controls of the credit card issuing entity may still be available to said entities.

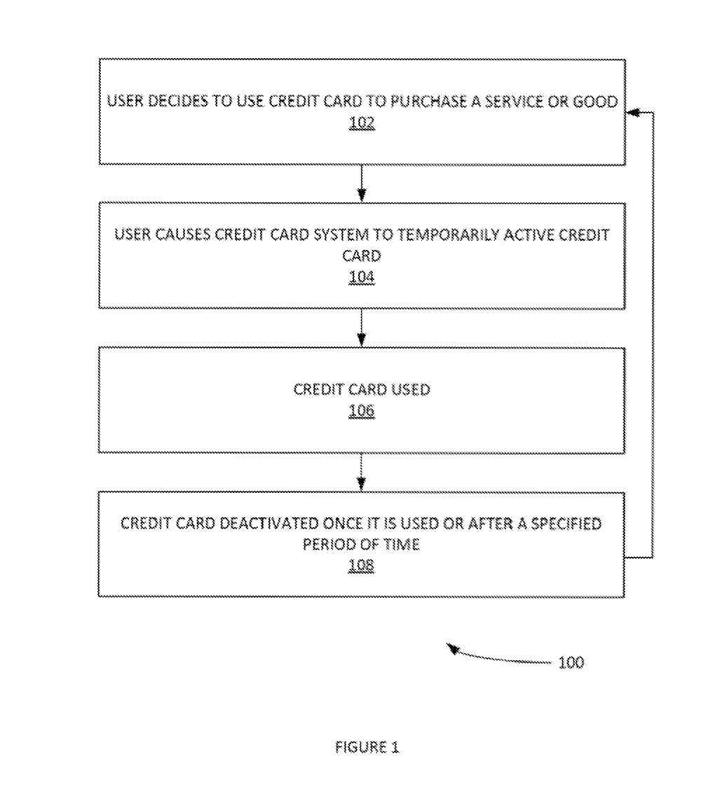

FIG. 1 illustrates an example process 100 for secure credit card commerce transactions, according to some embodiments. In step 102 of process 100, a user decides to use a credit card (or a debit card or other type of entity for electronic access to a bank or other financial account). In step 104, a user causes a credit card system to temporarily active the credit card. In step 106, it can be determined that the credit card used. In step 108, the credit card deactivated once it is used or after a specified period of time.

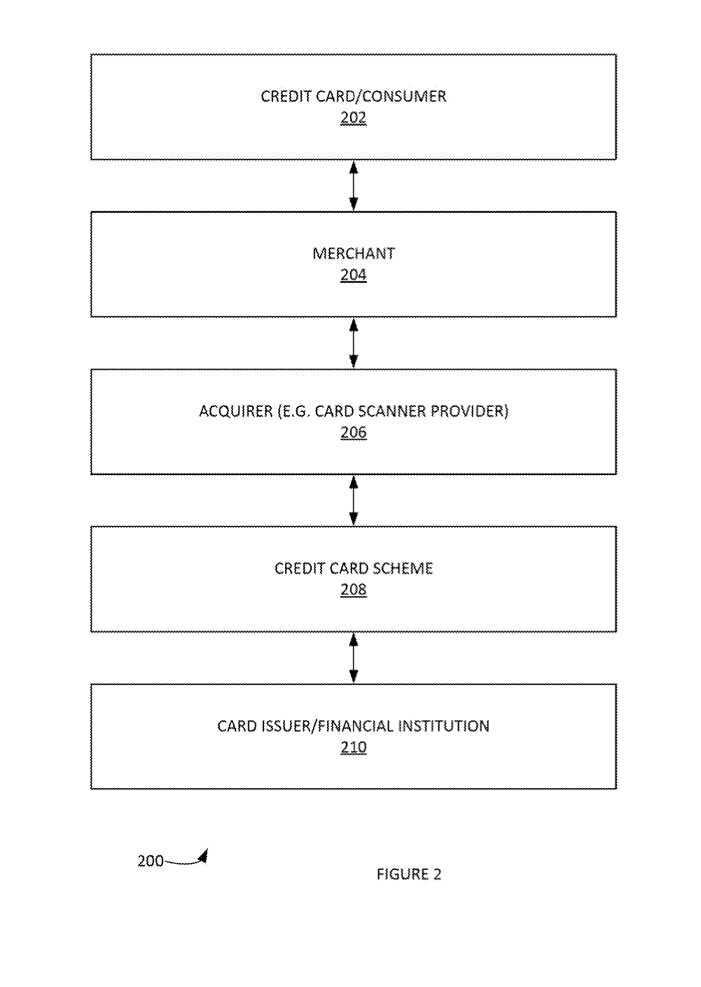

FIG. 2 illustrates an example system 200 of a credit-card processing model, according to some embodiments. Credit-card holders/consumers 202 can utilize credit cards to purchase goods/services from merchants 204. Merchants 204 can interact with acquirer entities to process said credit card transactions. Acquirer 206 can interact with a card-scheme entity. Card-scheme entity 208 can then in turn interact with an issuer and/or financial institution 210. It is noted that credit cards can include, inter alia: scheme-branded credit cards (e.g. Visa®, Master Card®, etc.), stand-alone credit cards (Discover®, AMEX®, etc.), scheme-branded bank debit cards and/or any generic merchant charge cards (Target®, Macys®, Home Depot®, etc.), debit cards, etc.

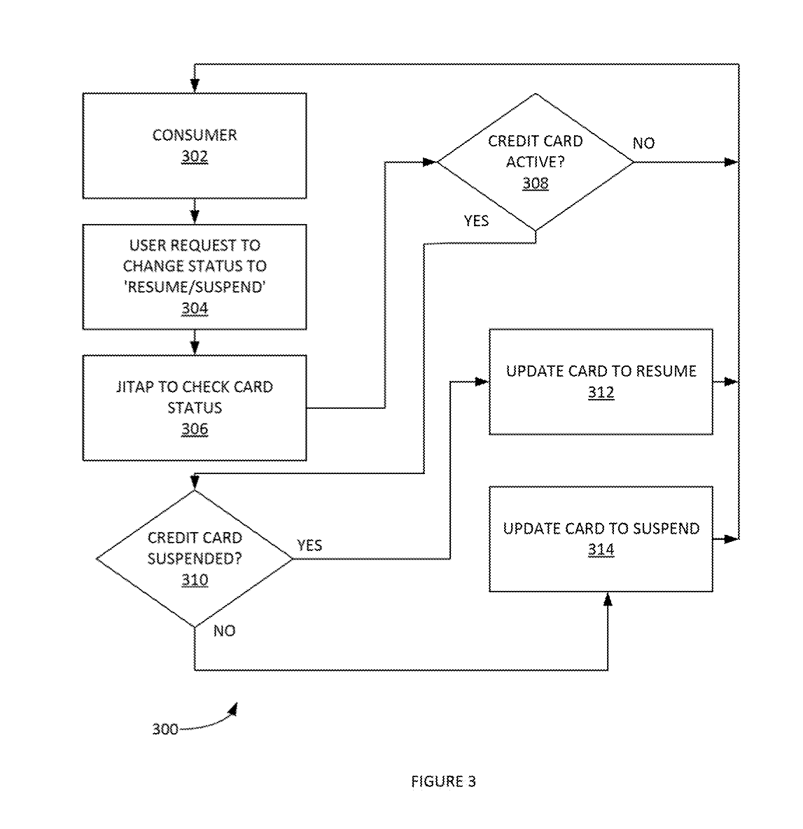

FIG. 3 illustrates an example model 300 of a process chain to enable/suspend/resume the active use a credit card, according to some embodiments. A user (e.g. a consumer 302) can request (e.g. using a mobile-device application) to resume or suspend the activity state of a credit card (or other type of card such as those provided elsewhere herein) in step 304. Various user authentication methods (password, biometrics, etc.) can be used to verify as a user before allowing access to a JITAP server. A JITAP can be used to check card status in step 306. In step 308, it can be determined if the card status is ‘active’?If ‘no’ then the updated card status can be communicated back to consumer. If ‘yes’, then, in step 310, it can be determined if the card status is ‘suspended’ in step. If ‘yes’, then the card status can be updated to ‘resume’ and the updated card status can be communicated back to consumer in step 312. If ‘no’ then the card status can be updated to ‘suspended’ and the updated card status can be communicated back to consumer in step 314. As shown, some steps of example model 300 can be performed by a JITAP server and/or in the servers of cash-schemes entities. JITAP servers can be used for both currency transaction vs non-currency transactions.

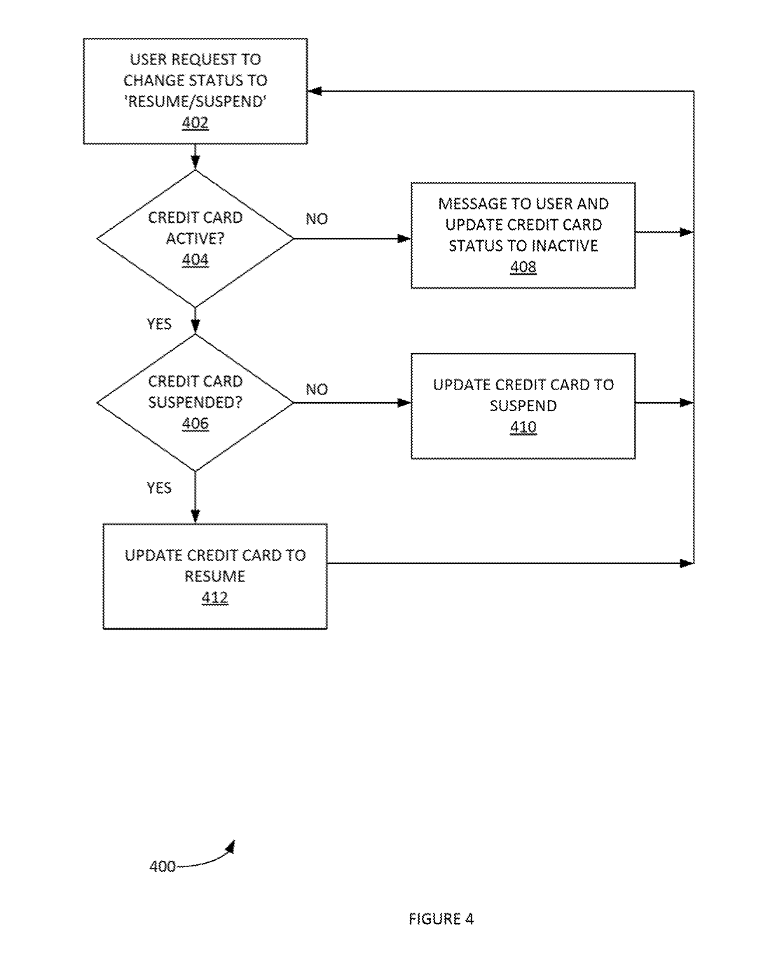

FIG. 4 illustrates a process flow 400 that can capture the resume/suspend operation with a card-scheme entity, according to some embodiments. A user can request to change the status of a credit card in step 402. In step 404, if the card is not active a message can be sent to the user (e.g. via text message, email, etc.) that the card is not active. If the credit card is inactive, in step 406, a message can be sent to the user that the credit card is inactive (e.g. an email, a text message, etc.). In in step 406, if the card is active, it can be determined if the card is in a suspended mode. If yes, then the card can be placed in a resume mode in step 412 and a message can be generated and communicated to the user. If no, then the card can be placed is a suspended mode in step 410 and a message communicated to the user.

Exemplary Computer Architecture and Systems

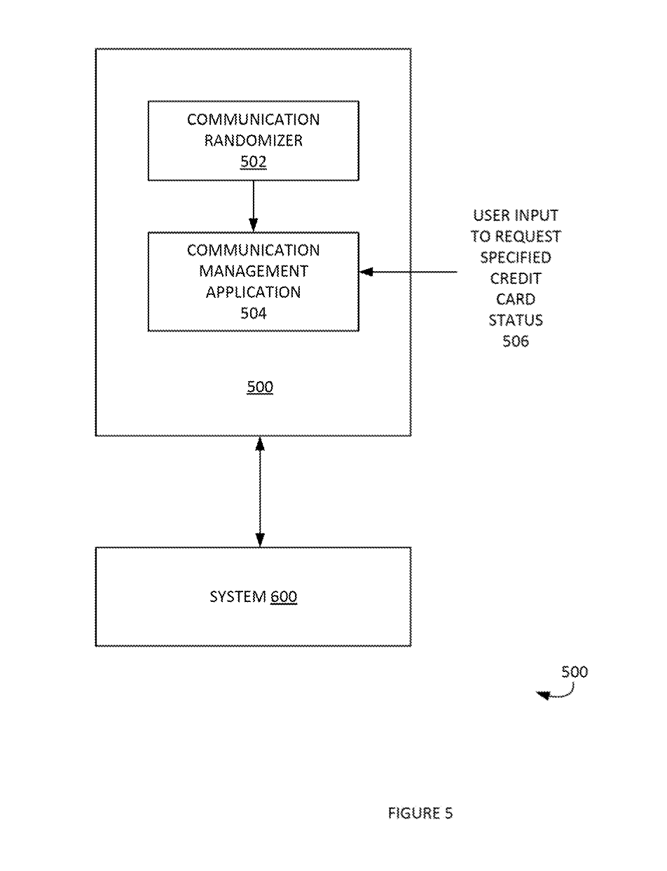

FIG. 5 illustrates an example system 500 of randomizing user communication to a computerized system that implements process 100-400, according to some examples. System 500 can implement consumer-specified communication methods (e.g. text messages, telephone or other voice input, email, etc.) can be randomized to randomly communicate to computerized system that implements process 100-400 (e.g. system 600 infra) through a specified communication mechanism, such that predictability for hackers to be know which communication channel the consumer is using is less likely. A user can have one or more computing devices that include application 502. Application 502 can manage a user-side aspect of implementing processes 100-400. Application 502 can include communication randomizer 502. Communication randomizer 502 can determine a form of communication (e.g. email, text message, file sharing, voice messaging, etc.) to communicate with system 600. Communication randomizer 502 can determine false communication methods as well. The true communication method can be pre-communicated to system 600. User input 506 can be received (e.g. to activate a credit card). The user intent can be communicated to system 600 by communication management application 504. This can be communicated via the random format selected by communication randomizer 502. System 600 can only follow the random format selected by communication randomizer 502. Several false communications can periodically be sent to system 600 via formats other than the random format selected by communication randomizer 502. These can be ignored by system 600.

The systems of FIGS. 5-8 can be used to implement the systems, models and/or processes of FIGS. 1-4, according to various embodiments. It is further noted that credit/debit cards can also be virtualized (e.g. virtual credit cards, virtualized ‘wallets’, virtual debit cards, etc.) in some embodiments. These virtualized cards can be applications that utilize NFC or other communication systems/protocols and can be implemented in a user's mobile device.

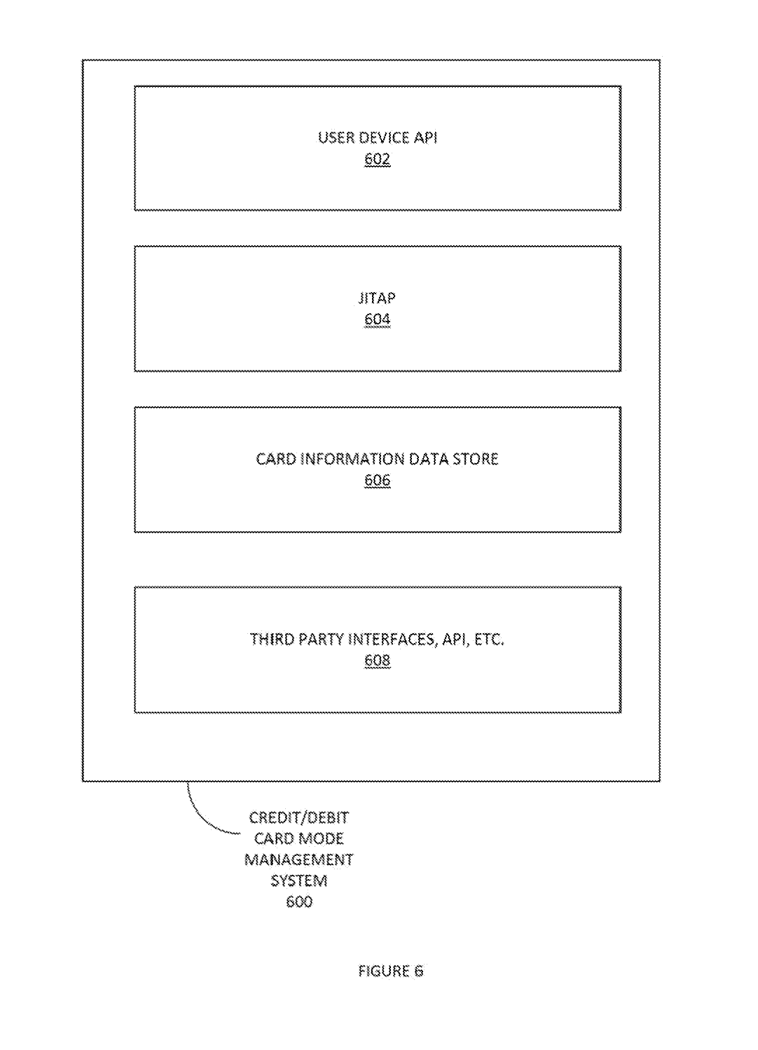

FIG. 6 depicts, in block diagram format, a credit/debit card mode management system 600, according to some embodiments. Credit/debit card mode management system 600 can be implemented in a server (e.g. accessible via a computer network such as the Internet). Credit/debit card mode management system 600 can be implemented in a cloud-computing environment. Credit/debit card mode management system 600 can include a user-device application programming interface (API) 602. User-device API can interface with credit/debit card mode management applications in various user computing devices (e.g. mobile devices, personal computers, etc.). User-device API can implement credit/debit card modes (e.g. activated, inactivated, suspended, etc.) according to user instructions. User-device API can implement credit/debit card modes (e.g. activated, inactivated, suspended, etc.) according to credit/debit card financial institution instructions. Credit/debit card mode management system 600 can include a JITAP 604. JITAP 604 can implement the various JITAP's functionalities provided herein. Credit/debit card mode management system 600 can include a card information data store 606. Card information data store 606 can include information about the credit/debit cards managed by the credit/debit card mode management system 600 (e.g. activation status, deactivation status, suspension status, credit limits, funds available, financial transaction histories, security information, user contact information, user mobile device IP address or other user computer network identifiers, associated financial institutions, etc.). This information can be provided to user applications and/or authorized third party entities (e.g. those discussed in FIGS. 1-5 that are related to the credit/debit card transactions). Card information data store 606 can include various third party interfaces, APIs, etc. 608. These can be utilized by third party entities (e.g. those discussed in FIGS. 1-5 that are related to the credit/debit card transactions, law enforcement entities, etc.) to obtain information from card information data store 606. Credit/debit card mode management system 600 can include other functionalities and/or modules for implementing the systems, processes and/or models of FIGS. 1-5.

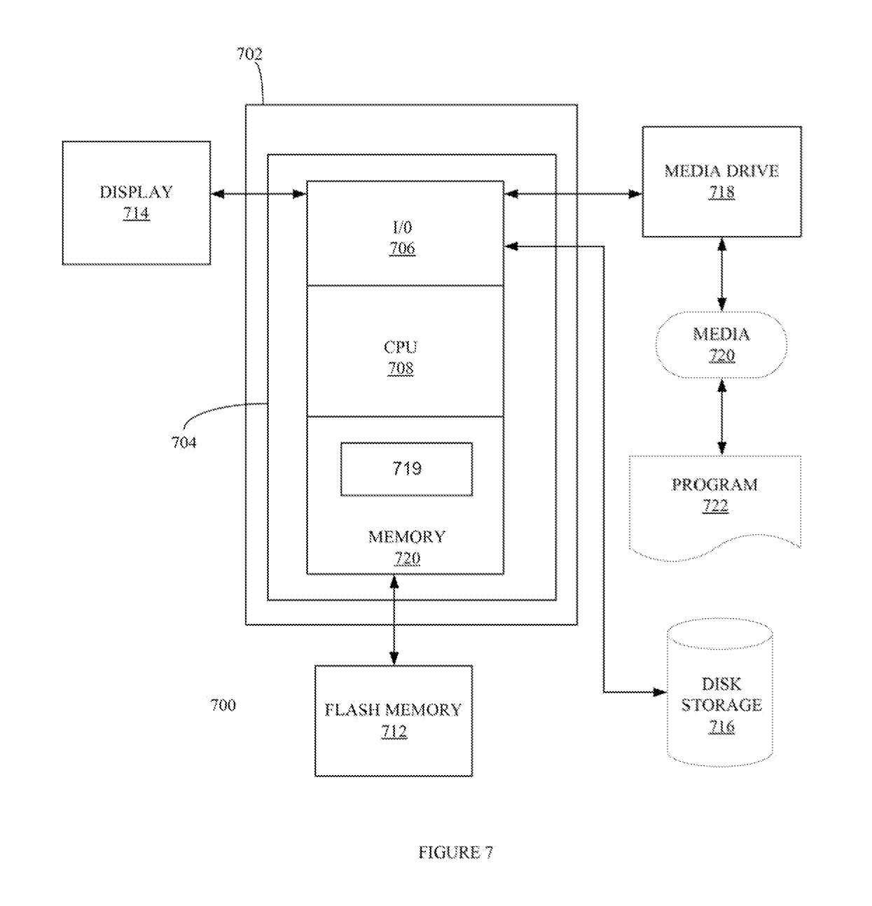

FIG. 7 depicts an exemplary computing system 700 that can be configured to perform any one of the processes provided herein. In this context, computing system 700 may include, for example, a processor, memory, storage, and I/O devices (e.g., monitor, keyboard, disk drive, Internet connection, etc.). However, computing system 700 may include circuitry or other specialized hardware for carrying out some or all aspects of the processes. In some operational settings, computing system 700 may be configured as a system that includes one or more units, each of which is configured to carry out some aspects of the processes either in software, hardware, or some combination thereof.

FIG. 7 depicts computing system 700 with a number of components that may be used to perform any of the processes described herein. The main system 702 includes a motherboard 704 having an I/O section 706, one or more central processing units (CPU) 708, and a memory section 710, which may have a flash memory card 712 related to it. The I/O section 706 can be connected to a display 714, a keyboard and/or other user input (not shown), a disk storage unit 716, and a media drive unit 718. The media drive unit 718 can read/write a computer-readable medium 720, which can contain programs 722 and/or data. Computing system 700 can include a web browser. Moreover, it is noted that computing system 700 can be configured to include additional systems in order to fulfill various functionalities. Computing system 700 can communicate with other computing devices based on various computer communication protocols such a Wi-Fi, Bluetooth® (and/or other standards for exchanging data over short distances includes those using short-wavelength radio transmissions), USB, Ethernet, cellular, an ultrasonic local area communication protocol, etc. In one example, computing system 700 can be a mobile device and include a module 719 that includes a credit/debit card mode application. In another example, computing system 700 can be a server system and include a module 719 that includes a credit/debit card mode management system (e.g. credit/debit card mode management system 600 in FIG. 6 supra).

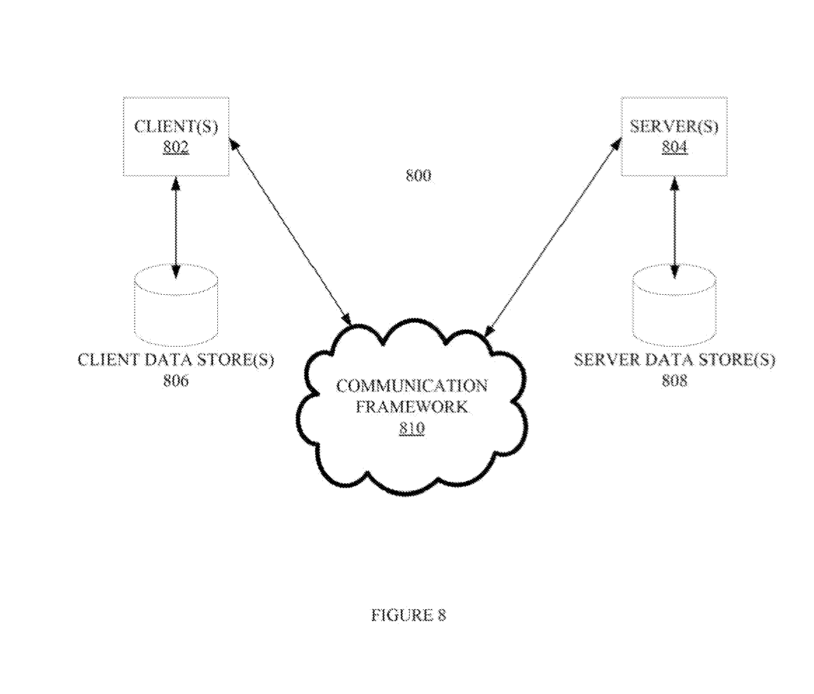

FIG. 8 illustrates another block diagram of a sample computing environment 800 with which embodiments may interact. The system 800 further illustrates a system that includes one or more clients 802. The client(s) 802 may be hardware and/or software (e.g., threads, processes, computing devices). The system 800 also includes one or more servers 804. The server(s) 804 may also be hardware and/or software (e.g., threads, processes, computing devices). One possible communication between a client 802 and a server 804 may be in the form of a data packet adapted to be transmitted between two or more computer processes. The system 800 includes a communication framework 810 that may be employed to facilitate communications between the client(s) 802 and the server(s) 804. The client(s) 802 are connected to one or more client data stores 806 that may be employed to store information local to the client(s) 802. Similarly, the server(s) 804 are connected to one or more server data stores 808 that may be employed to store information local to the server(s) 804.

### CONCLUSION

Although the present embodiments have been described with reference to specific example embodiments, various modifications and changes can be made to these embodiments without departing from the broader spirit and scope of the various embodiments. For example, the various devices, modules, etc. described herein can be enabled and operated using hardware circuitry, firmware, software or any combination of hardware, firmware, and software (e.g., embodied in a machine-readable medium).

In addition, it can be appreciated that the various operations, processes, and methods disclosed herein can be embodied in a machine-readable medium and/or a machine accessible medium compatible with a data processing system (e.g., a computer system), and can be performed in any order (e.g., including using means for achieving the various operations). Accordingly, the specification and drawings are to be regarded in an illustrative rather than a restrictive sense. In some embodiments, the machine-readable medium can be a non-transitory form of machine-readable medium.

What is claimed as new and desired to be protected by Letters Patent of the United States is:

1. A computerized method for secure credit card commerce transactions comprising:
receiving in a computer with a memory, from a user-side computing device, an electronic message that a user intends to use a credit card, wherein the electronic message comprises a request to activate the credit card, and wherein the credit card is initially in an inactive state;
with at least one processor of the computer implementing the following steps:
placing the credit card in an active state;
detecting that the credit card has been used for a commercial transaction; and
placing the credit card in an inactive state after it has been detected that the credit card has been used for a commercial transaction.

2. The computerized method of claim 1, wherein the credit card comprises a debit card.

3. The computerized method of claim 2, wherein the step of placing the credit card in an inactive state after it has been detected that the credit card has been used for a commercial transaction further comprises:
placing the credit card in an inactive state after a specified period of time after it has been detected that the credit card has been used for a commercial transaction.

4. The computerized method of claim 3, wherein the specified time comprises sixty (60) minutes.

5. A computerized system comprising:
a processor configured to execute instructions;
a memory containing instructions when executed on the processor, causes the processor to perform operations that:
discover the list of shopping intents and extract the list of shopping intents from the memory;
receiving in the memory, from a user-side computing device, an electronic message that a user intends to use a credit card, wherein the electronic message comprises a request to activate the credit card, and wherein the credit card is initially in an inactive state;
placing the credit card in an active state;
detecting that the credit card has been used for a commercial transaction; and
placing the credit card in an inactive state after it has been detected that the credit card has been used for a commercial transaction.

6. The computerized method of claim 5, wherein the credit card comprises a debit card.

7. The computerized method of claim 6, wherein the step of placing the credit card in an inactive state after it has been detected that the credit card has been used for a commercial transaction further comprises:
placing the credit card in an inactive state after a specified period of time after it has been detected that the credit card has been used for a commercial transaction.

8. The computerized method of claim 9, wherein the specified time comprises sixty (60) minutes.
